(19) United States
(12) Patent Application Publication
(10) Pub. No.: US 2008/0073408 A1
(43) Pub. Date: Mar. 27, 2008

(54) MOVABLE ELECTRONIC FLAME-OFF DEVICE FOR A BONDING APPARATUS

(76) Inventors: Ka Shing Kenny KWAN, Singapore (SG); Chong Hao CHEN, Singapore (SG); Gang OU, Singapore (SG); Keng Yew James SONG, Singapore (SG)

Correspondence Address: OSTROLENK FABER GERB & SOFFEN, 1180 AVENUE OF THE AMERICAS, NEW YORK, NY, 100368403, US

(21) Appl. No.: 11/534,268

(22) Filed: Sep. 22, 2006

(51) Int. Cl. A47J 36/02

(52) U.S. Cl. 228/101

(57) ABSTRACT

A bonding apparatus is provided that comprises a bonding tool for bonding wire onto an electronic device secured by a clamping device. The clamping device is locatable at a first position to clamp the electronic device during bonding and a second position at a raised height to release the electronic device for indexing. A flame-off torch is locatable adjacent to the bonding tool and is operative to produce sparks to melt a tip of the wire for bonding. An actuator is further provided that is operative to lower the flame-off torch close to the electronic device during bonding and to raise the flame-off torch away from the electronic device during indexing so as to provide a height clearance between the flame-off torch and the clamping device at its second position.

### FIELD OF THE INVENTION

The invention relates to wire bonding, and in particular to ball bonding wherein a molten ball is attached to a bonding surface to connect a length of bonding wire to the bonding surface.

### BACKGROUND AND PRIOR ART

Wire bonding is used to connect electrical contact points of different devices, or different electrical contact points of the same device.

FIG. 1 is a side view of a prior art wire bonding apparatus 100 comprising a fixed electronic flame-off (EFO) device. The wire bonding apparatus 100 includes a wire bonding tool comprising a horn 102 and a capillary 104, and also other components such as an ultrasonic transducer (not shown) for generating bonding energy. The EFO device, comprising a fixed mounting 106 and an EFO torch 108 attached to it, is positioned adjacent to the capillary 104 of the wire bonding tool. The capillary 104 is configured to travel between a first height 114 adjacent to the EFO torch 108 for sparking, and a second height 116 for bonding.

Bonding wire (not shown) is threaded through a centrally-located hole in the capillary 104 and extends from the narrow tip of the capillary 104. The bonding tool is arranged over an electronic device 110 to be bonded. The electronic device 110 typically comprises a die mounted onto a leadframe, and wire connections are usually made between the die and the leadframe. A window clamp 112 clamps and secures the electronic device 110 to a worktable. The window clamp 112 has an opening to expose a bonding area on the electronic device 110 at which wire bonding is to be conducted, for access by the capillary 104.

During operation, bonding wire hangs from the tip of the capillary 104. A ball on the end of the wire is formed by locating the EFO torch 108 at a predetermined distance from the end of the wire. An electrical arc is emitted between the end of the wire and the EFO torch 108. The arc forms a molten ball on the end of the bonding wire. By varying the intensity and the duration of the electrical arc, the size of the ball that is formed can be adjusted to specific dimensions. The molten ball is then attached to the bonding surface by the capillary 104 using force and power. Thereafter, the wire is extended to another bonding surface to form a second bond.

Although the EFO torch mounting 106 is manually adjustable to change its height relative to the window clamp 112, its height is essentially fixed once wire bonding operations are commenced.

FIG. 2 is a side view of the prior art bonding apparatus wherein the window clamp 112 is lifted away from the electronic device 110 in order to index the device with respect to the wire bonding apparatus 100. This is necessary when there is a need to bond another portion of the electronic device 110, or when another electronic device is to be bonded.

The window clamp 112 should be lifted by an indexing height 118 that leaves an EFO torch clearance 120 to avoid contact between the EFO torch 108 and the window clamp 112, but is sufficient to clear the electronic device 110 and the wire loops that have been bonded onto it. Therefore, since the fixed mounting 106 has to be positioned at a fixed height, the EFO torch 108 should in the first place be positioned at a height that would allow a sufficient EFO torch clearance 120 when the window clamp 112 is lifted by the appropriate indexing height 118. The top of the window clamp 112 typically includes ribs or other structures (not shown) extending across the opening of the window clamp 112, which the EFO torch 108 should also avoid contacting. The EFO torch 108 would thus have to be set at a high level.

Hence, since a spark is required to melt the bonding wire prior to making each wire connection, the capillary 104 must repeatedly travel between a sparking height 114 and a bonding height 116, which results in a relatively large distance to be traveled by the capillary 104 during each bonding cycle. Such a long travel distance is inefficient and time-consuming.

Another conventional EFO torch is described in Japanese Patent Publication No. JP2001-135670 entitled “Wire Bonding Apparatus and Its Using Method”. It describes an EFO electrode that is attached to a positioning mechanism wherein the position of the EFO electrode can be manually adjusted by loosening screws for the mechanism, adjusting as required and then tightening the screws. However, once the position of the EFO electrode is fixed, it is not movable and it encounters the same problem as previously described.

An improved EFO torch of the prior art wherein the EFO torch is configured to be movable is described in Japanese Patent Publication No. JP11-003906 entitled “Ball Forming Device for Wire Bonder”. In this disclosure, the EFO torch is mounted on a rocking arm that extends vertically. The rocking arm is supported on a horizontal supporting axle and is operable between a discharging position beneath the capillary and another position remote from the capillary. The EFO torch is moved between the two positions for every ball bond, which requires too much movement during each bonding cycle and results in increased complexity in design. Moreover, the EFO torch is movable towards or away from the capillary, but otherwise its height is substantially fixed, as in the previous prior art examples.

There is a constraint in the use of conventional EFO torches that are located at substantially fixed heights. On the one hand, the EFO torch needs to be as close as possible to the bonding surface to limit the distance that the capillary needs to travel for formation of the molten ball. On the other hand, the EFO torch has to be located at a sufficiently high level to allow a clearance when lifting the window clamp clamping the electronic device in order to move the electronic device.

### SUMMARY OF THE INVENTION

It is thus an object of the invention to seek to provide an EFO device that is movable to meet the contrary demands of locating an EFO torch as close as possible to an electronic device to be bonded during wire bonding, but is also able to create a sufficient clearance when a window clamp clamping the electronic device is lifted when the electronic device has to be moved.

According to a first aspect of the invention, there is provided a bonding apparatus comprising: a bonding tool for bonding wire onto an electronic device secured by a clamping device, wherein the clamping device is locatable at a first position to clamp the electronic device during bonding and a second position at a raised height to release the electronic device for indexing; a flame-off torch that is locatable adjacent to the bonding tool and is operative to produce sparks to melt a tip of the wire for bonding; an actuator operative to lower the flame-off torch close to the electronic device during bonding and to raise the flame-off torch away from the electronic device during indexing so as to provide a height clearance between the flame-off torch and the clamping device at its second position.

According to a second aspect of the invention, there is provided a method for bonding an electronic device with wire using a bonding tool, comprising the steps of: clamping the electronic device with a clamping device; activating an actuator to lower a flame-off torch adjacent to the bonding tool close to the electronic device for producing sparks to melt a tip of the wire for bonding; bonding the electronic device with the bonding tool; lifting the clamping device to a raised height to release the electronic device for indexing; and simultaneously activating the actuator to raise the flame-off torch away from the electronic device so as to provide a height clearance between the flame-off torch and the raised clamping device during indexing.

It would be convenient hereinafter to describe the invention in greater detail by reference to the accompanying drawings which illustrate preferred embodiments of the invention. The particularity of the drawings and the related description is not to be understood as superseding the generality of the broad identification of the invention as defined by the claims.

### BRIEF DESCRIPTION OF THE DRAWINGS

An example of a preferred embodiment of a bonding apparatus in accordance with the invention will now be described with reference to the accompanying drawings, in which:

FIG. 1 is a side view of a prior art wire bonding apparatus comprising a fixed EFO device;

FIG. 2 is a side view of the prior art bonding apparatus wherein a window clamp is lifted away from an electronic device in order to index a bonded leadframe with respect to the wire bonding apparatus;

FIG. 3 is a side view of a bonding apparatus comprising a movable EFO device according to the preferred embodiment of the invention;

FIG. 4 is a side view of the bonding apparatus wherein the window clamp is lifted away from an electronic device in order to index the device with respect to the wire bonding apparatus; and

FIG. 5 is a side view of the EFO device looking from direction A of FIG. 4 illustrating the main components of the EFO device.

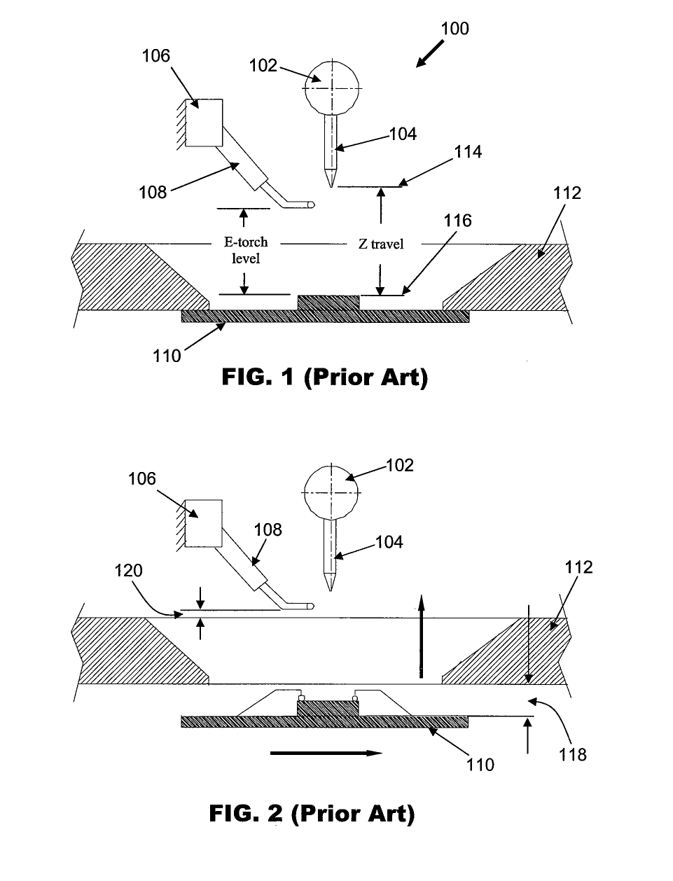

### DETAILED DESCRIPTION OF THE PREFERRED EMBODIMENT OF THE INVENTION

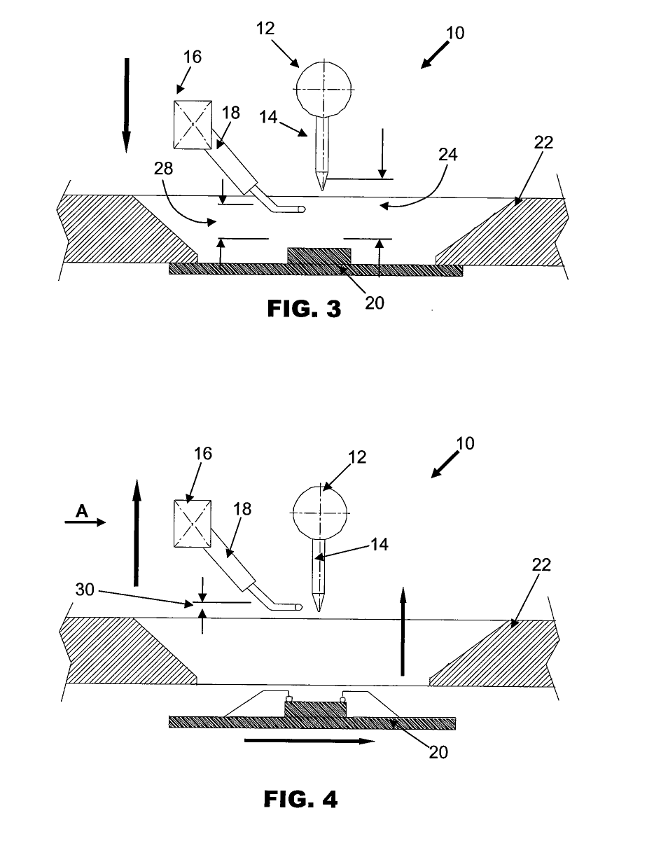

FIG. 3 is a side view of a bonding apparatus 10 comprising a movable electronic flame-off (EFO) device according to the preferred embodiment of the invention. The wire bonding apparatus 10 includes a wire bonding tool comprising a horn 12 and a capillary 14. An EFO device, comprising an EFO torch mounting 16 and an EFO torch 18 attached to it, is positioned adjacent to the capillary 14 of the wire bonding tool.

The bonding tool is arranged over an electronic device 20 to be bonded, which may comprise a die mounted onto a leadframe. Wire connections are to be made between the die and the leadframe. A clamping device, which may be in the form of a window clamp 22, is located at a first position to clamp the electronic device 20 to a worktable during bonding. The window clamp 22 has an opening or window to expose a bonding area on the electronic device 20 at which wire bonding is to be conducted, for access by the capillary 14.

During operation, bonding wire hangs from the tip of the capillary 14. The EFO torch 18 produces a spark that melts the wire into a molten ball. The ball of molten wire is then bonded to the electronic device, as explained above.

According to the preferred embodiment of the invention, the EFO torch mounting 16 is movable to change the height of the EFO torch 18, and the EFO torch 18 can thus be located at a lower position than in the conventional apparatus wherein the EFO torch mounting is fixed. In this case, the EFO torch 18 may even be moved to a height 28 that is at or below the top surface of the window clamp 22 during bonding. However, it should still be positioned higher than any ribs or other structure that is present across the opening of the window clamp 22, which should be avoided. At this low height, the capillary 14 needs to travel a shorter distance 24 to move between the electronic device 20 and a position adjacent to the EFO torch 18. Hence, travel time needed for the capillary to perform bonding is reduced. Moreover, the height of the EFO torch 18 is preferably fixed close to the electronic device 20 for the bonding of multiple bonding positions on the electronic device 20 so that bonding speed is further optimized by reducing unnecessary motion.

FIG. 4 is a side view of the bonding apparatus 10 wherein the window clamp 22 is lifted away from an electronic device 20 to a second position at a raised height in order to index the device with respect to the wire bonding apparatus 10. Along with the lifting of the window clamp 22, the movable EFO torch mounting 16 also lifts the EFO torch so that a height clearance 30 is maintained between the EFO torch 18 and the top surface of the window clamp 22. If necessary, the capillary 14 of the bonding tool is also lifted to provide a sufficient height clearance to avoid it hitting the window clamp 22.

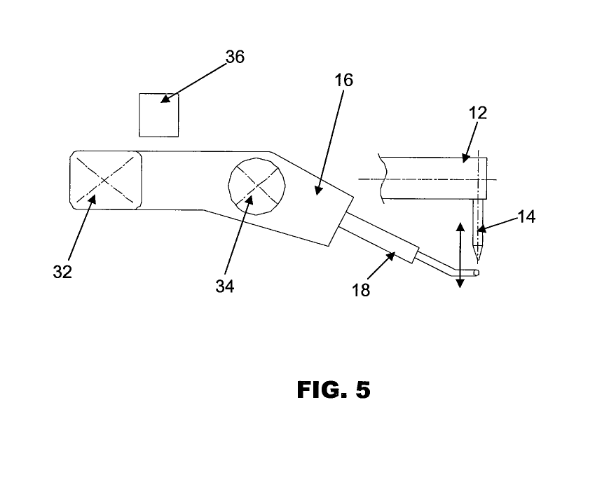

FIG. 5 is a side view of the EFO device looking from direction A of FIG. 4 illustrating the main components of the EFO device. The EFO torch mounting 16 is drivable for vertical motion by an actuator such as a linear actuator, which is preferably a voice coil motor 32. As explained above, the actuator is operative to lower the EFO torch 18 close to the electronic device 20 during bonding and to raise the EFO torch 18 away from the electronic device 20 during indexing so as to provide a height clearance between the EFO torch 18 and the window clamp 22 at its second position.

The EFO torch mounting 16 is pivotally mounted at a pivot 34 between the EFO torch 18 and the voice coil motor 32, which pivot 34 is mounted onto the wire bonding apparatus 10 or some other support. Upon driving of the EFO torch mounting 16 by the voice coil motor 32, the EFO torch 18 is made to move upwards or downwards relative to the horn 12 and capillary 14 of the bonding tool.

A position feedback sensor 36 is preferably included to monitor the position of the EFO torch mounting 16, and therefore of the EFO torch 18, at all times. With the position feedback sensor, the height of the EFO torch 18 can be controlled and programmed to any level by providing corresponding commands to the voice coil motor 32. For travel between two fixed levels, generally only the actuator is needed. However, for increased flexibility in having multiple programmable heights for positioning the EFO torch 18 within its travel range, both the actuator and position feedback sensor 36 would preferably be required.

It should be appreciated that the movable EFO torch mounting 16 in accordance with the preferred embodiment of the invention can be used to shorten the travel distance of the bonding tool from a position where sparking is performed to create a molten ball and a bonding position during bonding. This is useful to reduce bonding cycle time and increase the productivity of the wire bonding apparatus 10 as compared to the prior art.

The invention described herein is susceptible to variations, modifications and/or additions other than those specifically described and it is to be understood that the invention includes all such variations, modifications and/or additions which fall within the spirit and scope of the above description.

1. Bonding apparatus comprising:
a bonding tool for bonding wire onto an electronic device secured by a clamping device, wherein the clamping device is locatable at a first position to clamp the electronic device during bonding and a second position at a raised height to release the electronic device for indexing;
a flame-off torch that is locatable adjacent to the bonding tool and is operative to produce sparks to melt a tip of the wire for bonding;
an actuator operative to lower the flame-off torch close to the electronic device during bonding and to raise the flame-off torch away from the electronic device during indexing so as to provide a height clearance between the flame-off torch and the clamping device at its second position.

2. Bonding apparatus as claimed in claim 1, wherein the actuator is operative to maintain the flame-off torch at a fixed height close to the electronic device during bonding of multiple positions on the electronic device.

3. Bonding apparatus as claimed in claim 1, wherein the actuator is operative to move the flame-off torch to a height that is at or below a top surface of the clamping device during bonding.

4. Bonding apparatus as claimed in claim 1, wherein the actuator is a linear actuator to which the electronic flame-off device is coupled for vertical motion.

5. Bonding apparatus as claimed in claim 4, wherein the linear actuator comprises a voice coil motor.

6. Bonding apparatus as claimed in claim 4, further comprising a pivot located between the flame-off torch and the linear actuator for pivotally mounting the flame-off torch with respect to the linear actuator.

7. Bonding apparatus as claimed in claim 1, further comprising a position feedback sensor to monitor a position of the flame-off torch.

8. Bonding apparatus as claimed in claim 7, wherein the flame-off torch is positionable to multiple programmable heights within a travel range of the flame-off torch during operation.

9. A method for bonding an electronic device with wire using a bonding tool, comprising the steps of:
clamping the electronic device with a clamping device;
activating an actuator to lower a flame-off torch adjacent to the bonding tool close to the electronic device for producing sparks to melt a tip of the wire for bonding;
bonding the electronic device with the bonding tool;
lifting the clamping device to a raised height to release the electronic device for indexing; and simultaneously
activating the actuator to raise the flame-off torch away from the electronic device so as to provide a height clearance between the flame-off torch and the raised clamping device during indexing.

10. The method as claimed in claim 9, wherein the flame-off torch is maintained at a fixed height close to the electronic device during bonding of multiple positions on the electronic device.

11. The method as claimed in claim 9, wherein the flame-off torch is maintained at a height that is at or below a top surface of the clamping device during bonding.

12. The method as claimed in claim 9, wherein the actuator is a linear actuator to which the electronic flame-off device is coupled for vertical motion.

13. The method as claimed in claim 12, wherein the linear actuator comprises a voice coil motor.

14. The method as claimed in claim 12, wherein is the flame-off torch is moved pivotally with respect to the linear actuator during motion.

15. The method as claimed in claim 9, further comprising the step of monitoring a position of the flame-off torch with a position feedback sensor.

16. The method as claimed in claim 15, further comprising the step of positioning the flame-off torch to multiple programmable heights within a travel range of the flame-off torch during operation.
